(19) United States
(12) Patent Application Publication
(10) Pub. No.: US 2007/0051308 A1
(43) Pub. Date: Mar. 8, 2007

(54) Quick-change applicator system for coating a passing web

(75) Inventor: Evert Von Pander, Weiterstadt (DE)

Correspondence Address: THE FIRM OF KARL F ROSS, 5676 RIVERDALE AVENUE, PO BOX 900, RIVERDALE (BRONX), NY, 10471-0900, US

(73) Assignee: Fleissner GmbH

(21) Appl. No.: 11/517,560

(22) Filed: Sep. 7, 2006

(30) Foreign Application Priority Data
Sep. 7, 2005 (DE) 102005042469.4

(51) Int. Cl. B05C 11/00; B05C 5/00

(52) U.S. Cl. 118/686; 118/325; 118/313; 118/679

(57) ABSTRACT

A system for applying a treatment liquid to a passing web has two applicators spaced apart in a travel direction of the web and extending over a width of the web. Each applicator has a flow surface having a lower edge juxtaposed with the web and extending a width of the web and a reservoir extending the width of the web and having an angled downstream surface having an upper edge forming at an upper edge of the lower flow surface a first overflow. Each reservoir is fed a treatment liquid so that the liquid rises therein and flows up the downstream surface, over the overflow, and down the flow surface to the web. A controller synchronously operates the supplies while the web is moving and at an offset dependent on a travel speed of the web for switching from one of the applicators to the other of the applicators.

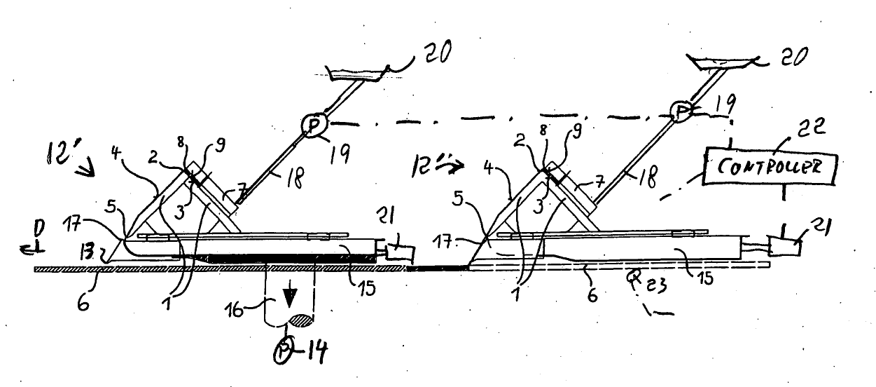

### FIELD OF THE INVENTION

The present invention relates to an applicator system for applying a liquid to a passing web. more particularly this invention concerns such a system used to dye or color a web.

### BACKGROUND OF THE INVENTION

An apparatus for applying a uniform-thickness liquid layer film in laminar flow to a continuously advancing fabric web across a large working width typically has a liquid reservoir that is defined by a downstream surface that is directed diagonally upward to the horizontal and extends across the working width, which surface ends in the direction of liquid flow at a spillover edge or overflow. A guide surface extends at an angle downward from the first overflow edge and has a lower end from which the overflowing liquid film runs off onto the fabric web. A pump supplies a liquid, e.g. a dye, to the reservoir. Such a system is shown in U.S. Pat. No. 5,243,841 and in U.S. patent application Ser. No. 10/535,957. Such an applicator guarantees even application of the treatment liquid in any desired amount across the-working width of the web.

It is also known to provide two applicators, of which only one in fact applies the color. To accomplish this, the guide surface of an applicator is associated with two liquid distribution units, which can be pivoted into and out of an active position as needed as the fabric web advances at unchanged speed. This solution comprises a lot of mechanical parts in the pivot apparatus and does not satisfy the need for a fast color change with a clean, sharp-edged color transition.

It is also known to provide two applicators, one next to the other. Such a system is used to apply two different dyes to the web.

A general defect of these systems is that the applicators cannot readily be switched from one color to another. If two different color supplies are connected to one applicator, the changeover process is slow and a substantial amount of web is made unusable as the old color is flushed out of the applicator reservoir, since in many production processes it is not possible to stop the web during the color change. Similarly such systems normally require that the entire production process be shut down to clean the applicator, and normally also to change treatment liquid or any other parameter of the coating operation.

### OBJECTS OF THE INVENTION

It is therefore an object of the present invention to provide an improved applicator system.

Another object is to provide such a system that allows a color change to be effected or an applicator to be cleaned or serviced without stopping advance of the web.

### SUMMARY OF THE INVENTION

A system for applying a treatment liquid to a passing web has according to the invention two applicators spaced apart in a travel direction of the web and extending over a width of the web. Each applicator has a flow surface having a lower edge juxtaposed with the web and extending a width of the web and a reservoir extending the width of the web and having an angled downstream surface having an upper edge forming at an upper edge of the lower flow surface a first overflow. Each reservoir is fed a treatment liquid so that the liquid rises therein and flows up the downstream surface, over the overflow, and down the flow surface to the web. A controller synchronously operates the supplies while the web is moving and at an offset dependent on a travel speed of the web for switching from one of the applicators to the other of the applicators. Each liquid supply includes a pump for supplying the liquid to the respective reservoir and a sump/trap underneath the flow-surface lower edge and above the web and shiftable between a retracted position permitting the respective liquid to flow off the respective lower edge and drop onto the web and an advanced position intercepting the liquid and preventing it from dropping onto the web. The controller shifts the sump/traps synchronously between their retracted and advanced positions as the respective pumps are turned on and off.

With this system as a result of the time-activated operation the applied color does not exceed the color absorbency of a fabric web and the unused section of the fabric web is minimized. Furthermore, for a color change, the pump of the first applicator is stopped and that of the next one is activated, specifically such that no double colorations and also no uncolored sections are created on the fabric web. This control of the two pumps is easily possible at a predefined distance of the applicators as a function of the fabric web speed.

The sump/traps can ensure that liquid is only dropped onto the web when the applicators are operating smoothly. Thus at the start of a production cycle, the sumps trap all the downflowing liquid until flow is stabilized and uniform coating is assured, at which time web advance is started and the sump/trap is retracted. Similarly once a job is completed or if for some reason web advance is stopped, the sump/trap is advanced to stop application of the liquid or ensure a clean end to the color job. The collection sump allows the exact determination of the start-or the end of the application phase within seconds. The liquid that has drained into the collection sump can be reused, or it can be disposed of into the drain during a rinsing operation by means of corresponding valves. A pump may be provided in the drain to ensure that the liquid collecting in the liquid collection sump is always completely removed. As a result, the color change is exactly optimized to just a few centimeters of fabric web length across the entire web width.

### BRIEF DESCRIPTION OF THE DRAWING

The above and other objects, features, and advantages will become more readily apparent from the following description, reference being made to the accompanying drawing whose sole figure is a schematic side view of the applicator system of this invention.

### SPECIFIC DESCRIPTION

As seen in the drawing, each of two identical liquid applicators 12′ and 12″ has an L-shaped body or beam 1 defining a planar flow surface 4 extending at an angle of about 45° to a horizontal displacement direction D of a moving textile web 6. The surface 4 extends from a lower edge 5 to an upper overflow edge 2. A reservoir 8 has a planar downstream surface 3 defined by one leg of the L-section beam 1, extending perpendicular from the surface 4, and meeting same at the overflow edge 2a and a parallel upstream wall defined by a downstream surface of a rectangular-section spacer bar 7 bolted to the beam 1 and spaced therefrom. A row of supply conduits 18 extend from the lower end of the reservoir 8 to a pump 19 whose intake is connected to a liquid supply 20. Both pumps 19 are connected to a computer-type controller 22. The design of the retaining and liquid distribution unit may also be varied; the only essential aspect is the necessity that the liquid to be poured on runs down the guide surface 4 and drains as a wide curtain from the edge 5 onto the fabric web 6.

Of these two applicators 12′ and 12″, one is always in operation, that is its pump 19 is operating so that liquid is flowing down its surface 4 and dropping like a curtain on the workpiece 6. In practice one of the applicators is normally working and the other is in effect a spare that operates only when the one is being serviced, e.g. cleaned. It is also of course possible to load one of the supplies 20 with ink of one color and the other supply 20 with ink of another color so that, as described below, it is possible to make a quick color change.

In order to ensure the sudden change of dyes, a liquid-collection trap or sump 15 with a drain 16 is provided above the web 6 but below the beam 1. This sump 15 is movable like a drawer parallel to the direction D between the advanced position it assumes in the applicator 12′ and the retracted position in the applicator 12″. In the retracted position an outer end face 17 of the sump 15 forms a smooth coplanar continuation of the surface 5 so that liquid running down the surface 4 flows smoothly over the end face 17 and drops from a lower edge 13 thereof onto the workpiece web 6. In the advanced position shown for the applicator 12′ the liquid curtain drops off the edge 5 into the sump 15 and moves off through the drain 16 that itself can be provided with a pump 14 to ensure its rapid emptying.

With this system it is therefore possible to load the two supplies with inks of different colors. To effect a color change from one of the applicators 12′ or 12″ to the other the controller 22 can simultaneously reverse the positions of the containers 15, that is move the one out and the other in. This will leave an uncoated region only as long as the longitudinal distance between the two applicators 12′ and 12″. It is also possible for the controller 22 to monitor the travel speed of the web 6, for instance by means of a sensor shown schematically at 23, and trigger the actuators 21 for displacement of the one sump 15 and then the other. For example to switch from the downstream applicator 12′ to the upstream applicator 12″, the upstream sump 15 is retracted and, just as the leading edge of the ink applied by the upstream applicator 12″ comes under the downstream applicator 12′, the downstream sump 15 is advanced. Similarly, to switch from the upstream applicator 12″ to the downstream applicator 12′, the sump 15 of the upstream applicator 12″ is advanced and, when the downstream edge of the coated area moves slightly past the downstream applicator 12′, its sump 15 is retracted. This system therefore makes it possible to reduce waste of the web 6 to very little.

Alternately one of the controllers 12′ or 12″ can merely be used while the other is serviced. For example the applicator 12′ is normally used, but when it needs cleaning, the other applicator 12″ is employed while a liquid is flushed through its reservoir 8 and so on. In this case the switchover from one applicator to the other is effected as described above for a color change.

I claim:

1. A system for applying a treatment liquid to a passing web, the system comprising:
two applicators spaced apart in a travel direction of the web and extending over a width of the web, each applicator having
a flow surface having a lower edge juxtaposed with the web and extending a width of the web,
a reservoir extending the width of the web and having an angled downstream surface having an upper edge forming at an upper edge of the lower flow surface a first overflow, and
supply means for feeding liquid to the reservoir so that the liquid rises therein and flows up the downstream surface, over the overflow, and down the flow surface to the web; and
control means for synchronously operating the supplies while the web is moving and at an offset dependent on a travel speed of the web for switching from one of the applicators to the other of the applicators.

2. The liquid-applying system defined in claim 1 wherein each of the supply means further comprises
a pump for supplying the liquid to the respective reservoir; and
a sump/trap underneath the flow-surface lower edge and above the web and shiftable between a retracted position permitting the respective liquid to flow off the respective lower edge and drop onto the web and an advanced position intercepting the liquid and preventing it from dropping onto the web,
the control means shifting the sump/traps synchronously between their retracted and advanced positions as the respective pumps are turned on and off.

3. The liquid-applying system defined in claim 2 wherein each of the sump/traps is shiftable generally parallel to the travel direction between the retracted and advanced positions and has an outer end face substantially coplanar with the respective flow surface in the retracted position.

4. The liquid-applying system defined in claim 2 wherein each of the sump/traps has a drain.

5. The liquid-applying system defined in claim 2 wherein the travel direction is horizontal and the applicators are fixedly spaced horizontally from each other.

6. The liquid-applying system defined in claim 2 wherein the control means is provided with means for monitoring the travel speed of the web.

7. The liquid-applying system defined in claim 6 wherein the control means operates the pumps to supply the respective liquids at a rate dependent on the travel speed of the web.
